(19) United States
(12) Patent Application Publication
(10) Pub. No.: US 2026/0235055 A1
(43) Pub. Date: Aug. 13, 2026

(54) CONTROL DEVICE FOR INTERNAL COMBUSTION ENGINE

(71) Applicant: TOYOTA JIDOSHA KABUSHIKI KAISHA, Toyota-shi (JP)

(72) Inventors: Naoya OKUBO, Chiryu-shi (JP); Tomohiro Watanabe, Chiryu-shi (JP); Shigetoshi Okuda, Nisshin-shi (JP); Masanao Idogawa, Nagoya-shi (JP); Takahiro Uchida, Okazaki-shi (JP)

(73) Assignee: TOYOTA JIDOSHA KABUSHIKI KAISHA, Toyota-shi (JP)

(21) Appl. No.: 19/442,106

(22) Filed: Jan. 7, 2026

(30) Foreign Application Priority Data
Feb. 7, 2025 (JP) 2025-018993

(51) Int. Cl. F01M 1/10; F01M 13/00

(52) U.S. Cl. CPC F01M 1/10; F01M 13/0011; F01M 2250/60

(57) ABSTRACT

A control device for an internal combustion engine includes a second valve that is controlled to open and close a communication pipe line that communicates an oil tank that receives and stores oil and blow-by gas and an intake system, and a controller that controls the second valve, in which the controller includes a stop detection unit that detects a stop from a driving state of the internal combustion engine, a pressure measurement unit that measures a pressure of the oil tank in a case where the internal combustion engine is stopped, and a valve opening instruction unit that opens the second valve for a predetermined period to introduce air of the intake system into the oil tank in a case where a pressure measured by the pressure measurement unit is equal to or lower than a predetermined pressure.

### CROSS-REFERENCE TO RELATED APPLICATION

This application claims priority to Japanese Patent Application No. 2025-018993 filed on February 7, 2025. The disclosure of the above-identified application, including the specification, drawings, and claims, is incorporated by reference herein in its entirety.

### BACKGROUND

### 1. Technical Field

The present disclosure relates to a device that controls an internal combustion engine mounted on a vehicle or the like, and particularly relates to a control device for a dry sump internal combustion engine in which oil is temporarily stored in an oil tank provided separately from a main body part of the internal combustion engine.

### 2. Description of Related Art

An example of the dry sump internal combustion engine (hereinafter, referred to as an engine) is described in Japanese Patent No. 6502596 (JP 6502596 B). To briefly describe a configuration thereof, a scavenging pump that pumps oil from a crankcase, an oil pan, or the like is provided, and an oil tank that temporarily stores oil pumped by the scavenging pump is provided separately from the engine. An oil pump (or a feed pump) that supplies oil inside the oil tank to a demanding part of the engine is further provided. Since a blow-by gas is mixed in the crankcase, the scavenging pump sends not only oil but also the blow-by gas to the oil tank, so that a pressure inside the oil tank may be increased. In a case where the pressure inside the oil tank is increased, oil may leak out. Therefore, a PCV valve is usually provided, and a gas inside is discharged to an intake side when the pressure reaches a certain level. That is, since the blow-by gas is sent from an engine side to the oil tank, the gas in the oil tank is returned to an intake system of the engine, and is not leaked into the atmosphere. In addition, a liquid-gas separation structure that separates oil and gas is provided inside the oil tank, and the liquid oil is not mixed into the intake system of the engine.

On the other hand, an oil supply device configured to eliminate a negative pressure of an oil tank that temporarily stores oil for lubrication is described in Japanese Unexamined Patent Application Publication No. 2018-44448 (JP 2018-44448 A). The oil tank described in JP 2018-44448 A is an oil tank that receives oil discharged from a bearing portion of a turbocharger. The bearing portion is configured to branch and supply a part of oil supplied to various lubrication parts in the engine, and thus the oil tank communicates with each of the lubrication parts of the engine. The oil accumulated in the oil tank is returned to an oil pan of the engine by a scavenging pump driven by the engine. In a case where the engine is stopped, the scavenging pump is also stopped. However, since the scavenging pump is a pump that acts to suction oil from the oil tank, the oil tank may be in a negative pressure in a case where the scavenging pump is stopped. Since the oil tank communicates not only with the bearing portion of the turbocharger but also with each of the lubrication parts of the engine, when the oil tank is in a negative pressure, oil may be suctioned from the bearing portion of the turbocharger or each of the lubrication parts of the engine. In the device of JP 2018-44448 A, an electromagnetic valve that is opened in a case where the engine is stopped is provided to communicate with the oil tank. In a case where the engine is stopped, a blow-by gas or outside air is introduced into the oil tank to avoid or reduce a state in which the oil tank is maintained in a negative pressure.

### SUMMARY

In the dry sump engine described in JP 6502596 B, the oil tank is connected to the intake system of the engine via the PCV valve. In a case where the pressure inside the oil tank is a high pressure (positive pressure) higher than a pressure of the intake system by a predetermined amount or more, a gas such as the blow-by gas is discharged from the oil tank to the intake system. Therefore, in a case where the engine is stopped from a state in which the engine is performing an idle operation or the like and is intaking air, the suction in the intake system is not performed, the PCV valve is closed, and the scavenging pump is stopped, so that the inside of the oil tank is in a negative pressure. In such a state, a suction action occurs in the oil tank, and abnormal noise due to the intake or the suction of the oil may occur, or the oil may flow back, which may cause insufficient lubrication at lubrication parts.

In the device described in JP 2018-44448 A, since the electromagnetic valve is opened to cause the oil tank and the oil pan of the engine to communicate with each other, the oil may be suctioned together with the blow-by gas, and abnormal noise may occur. In addition, the electromagnetic valve is provided in the middle of a pipe line communicating with the oil pan. Therefore, in a case where the electromagnetic valve is broken in an open state, the oil and the blow-by gas circulate between the oil pan (chain case) and the scavenging pump. As a result, the oil in the oil tank may not be returned to the oil pan or the like.

Furthermore, JP 2018-44448 A describes that a breather port is provided in the oil tank, and the breather port is opened and closed by an electromagnetic valve to suction the outside air and eliminate a negative pressure inside the oil tank. However, in such a configuration, in a case where the electromagnetic valve fails, the blow-by gas may be leaked to the outside, and predetermined regulations specified for vehicles may not be conformed to.

The present disclosure has been made in view of the above technical problem. An object of the present disclosure is to provide a control device that can reduce occurrence of an excessive negative pressure of an oil tank provided separately from an internal combustion engine or abnormal noise caused by the excessive negative pressure.

In order to achieve the above object, the present disclosure provides a control device for an internal combustion engine that outputs power by combusting an air-fuel mixture of air suctioned through an intake system and fuel, the internal combustion engine including an oil tank that receives oil for lubricating the internal combustion engine and a blow-by gas generated by combustion from the internal combustion engine, stores the oil and the blow-by gas, and returns the oil to the internal combustion engine, the internal combustion engine being provided with a first valve that is opened in a case where a pressure inside the oil tank is increased and discharges a gas from the oil tank to the intake system, the control device including:

a second valve that is controlled to open and close a communication pipe line that causes the oil tank and the intake system to communicate with each other; and

a controller configured to control the second valve,

in which the controller includes

a stop detection unit configured to detect that the internal combustion engine is stopped,

a pressure measurement unit configured to measure a pressure of the oil tank when the internal combustion engine is stopped, and

a valve opening instruction unit configured to open the second valve for a period specified in advance to introduce the air of the intake system to the oil tank in a case where the pressure measured by the pressure measurement unit is equal to or lower than a pressure specified in advance.

In the present disclosure,

the period specified in advance may be any of a period until the pressure of the oil tank is increased to the pressure specified in advance or a time specified in advance that elapses after the second valve is opened.

In the present disclosure,

the controller may further include

a start request detection unit configured to detect that there is a start request to start the internal combustion engine, and

a valve closing instruction unit configured to close the second valve in a case where the start request detection unit detects that there is the start request during the period specified in advance.

In the present disclosure,

the controller may further include a failure determination unit configured to determine that the pressure measurement unit fails to measure the pressure, and

the valve opening instruction unit may be configured to open, in a case where the failure determination unit determines that the pressure measurement unit fails to measure the pressure, the second valve for a time specified in advance when the internal combustion engine is stopped.

In addition, the present disclosure provides

a control device for an internal combustion engine that outputs power by combusting an air-fuel mixture of air suctioned through an intake system and fuel, the internal combustion engine including an oil tank that receives oil for lubricating the internal combustion engine and a blow-by gas generated by combustion from the internal combustion engine, stores the oil and the blow-by gas, and returns the oil to the internal combustion engine, the internal combustion engine being provided with a first valve that is opened in a case where a pressure

inside the oil tank is increased and discharges a gas from the oil tank to the intake system, the control device including:

a second valve that is controlled to open and close a communication pipe line that causes the oil tank and the intake system to communicate with each other; and

a controller configured to control the second valve,

in which the controller includes

a start detection unit configured to detect that a power supply for starting the internal combustion engine is turned on,

a pressure measurement unit configured to measure a pressure of the oil tank at a time point when the start detection unit detects that the power supply is turned on, and

a valve closing instruction unit configured to open the second valve in a case where the pressure measurement unit detects that the pressure of the oil tank at the time point when the start detection unit detects that the power supply is turned on is equal to or lower than a pressure specified in advance, and then close the second valve in a case where the pressure of the oil tank is increased to a predetermined pressure.

In the present disclosure,

the controller may further include a start request unit configured to enable start of the internal combustion engine in a case where the valve closing instruction unit issues an instruction to close the second valve.

According to the present disclosure, in a case where the internal combustion engine is stopped from a driving state and the pressure of the oil tank is decreased, the second valve is opened to introduce air from the intake system of the internal combustion engine into the oil tank. In addition, since an open state of the second valve is maintained, even in a case where the internal combustion engine is stopped, until the pressure of the oil tank is increased to a predetermined pressure or for a predetermined elapsed time, it is possible to reliably increase the pressure of the oil tank to the predetermined pressure. As a result, an excessive decrease in the pressure of the oil tank is avoided. Therefore, it is possible to avoid a state in which the oil tank suctions the oil or the blow-by gas from the internal combustion engine or the like, or to avoid occurrence of abnormal noise caused by the suctioning. In addition, since the second valve is provided between the oil tank and the intake system, even in a case where the second valve is broken in the open state, the blow-by gas inside the oil tank is suctioned by the internal combustion engine through the intake system, and is not leaked to the outside.

In a case where the internal combustion engine is started during a predetermined period in which the second valve is opened, the second valve is closed. Therefore, since air that the internal combustion engine intakes is the outside air provided through the intake system, it is possible to avoid an abnormality in control of the intake of air of the internal combustion engine.

Furthermore, in a case where determination is made that the pressure of the oil tank in a case where the internal combustion engine is stopped cannot be measured, the second valve is opened for a predetermined time regardless of the pressure of the oil tank. Therefore, the pressure of the oil tank can be set to a predetermined pressure such as a pressure in the intake system or a pressure close to the pressure in the intake system.

In the present disclosure, in a case where the power supply for starting the internal combustion engine is turned on, the second valve is first opened in a case where the pressure of the oil tank is equal to or lower than a predetermined pressure. Therefore, it is possible to increase the pressure of the oil tank, and in a case where there is a request to start the internal combustion engine thereafter, the second valve is closed, so that it is possible to avoid an abnormality in the control of the intake of air of the internal combustion engine.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing a drive system of a hybrid electric vehicle equipped with an engine according to an embodiment of the present disclosure;

FIG. 2 is a schematic diagram for describing a configuration of a dry sump engine according to the embodiment of the present disclosure;

FIG. 3 is a block diagram showing a functional configuration of a controller;

FIG. 4 is a flowchart for describing an example of control executed in the embodiment of the present disclosure;

FIG. 5 is a time chart showing a change in a state of the hybrid electric vehicle in a case where the control of FIG. 4 is executed;

FIG. 6 is a time chart showing a change in a state of the hybrid electric vehicle in a case where a start request of the engine is made during the control of opening the control valve;

FIG. 7 is a flowchart for describing another example of the control executed in the embodiment of the present disclosure;

FIG. 8 is a time chart showing a change in a state of the hybrid electric vehicle in a case where the control of FIG. 7 is executed;

FIG. 9 is a flowchart for describing still another example of the control executed in the embodiment of the present disclosure; and

FIG. 10 is a time chart showing a change in a state of the hybrid electric vehicle in a case where the control of FIG. 9 is executed.

### DETAILED DESCRIPTION OF EMBODIMENTS

Next, an embodiment of the present disclosure will be described with reference to the accompanying drawings. The embodiment described below is merely an example of a case where the present disclosure is implemented, and does not limit the present disclosure.

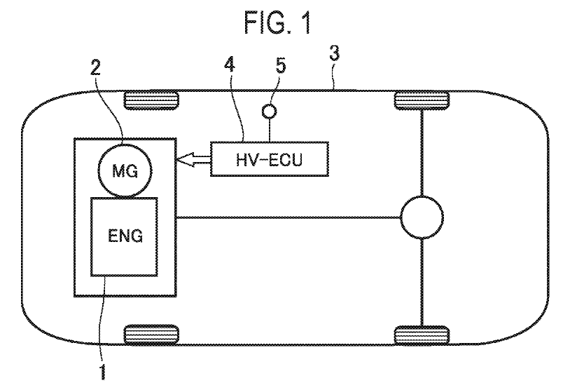

An internal combustion engine (ENG. Hereinafter, referred to as an engine) 1 is a power machine that generates power by burning an air-fuel mixture of fuel and air, and as schematically shown in FIG. 1, a motor or a motor-generator (MG. Hereinafter, referred to as a motor) 2 is mounted on a hybrid electric vehicle 3 as a driving force source. The hybrid electric vehicle 3 can switch a traveling mode according to a traveling state of the vehicle, such as a requested driving force represented by a depression angle of an accelerator pedal (not shown) or a vehicle speed. The traveling mode includes a motor traveling mode in which the vehicle travels by the motor 2, a hybrid mode in which the vehicle travels by the motor 2 and the engine 1, and an engine traveling mode in which the vehicle travels by the engine 1. The switching of the traveling modes and the control of the driving force source are performed by a hybrid electronic control device (HV-ECU) 4. In addition, an IG switch 5 that turns on the power supply to start at least the engine 1 of the driving force source is provided in the hybrid electric vehicle 3. The IG switch 5 is connected to the HV-ECU 4. Then, the HV-ECU 4 is configured to control the driving force source in any of the traveling modes based on the traveling state of the vehicle, such as the requested driving force, the vehicle speed, and a state of charge (SOC) of a power storage device (not shown), after the IG switch 5 is turned on.

Therefore, the engine 1 is started not only immediately after the IG switch 5 is turned on to start the traveling, but also in a case where the traveling mode is switched from the motor traveling mode to the hybrid mode or the engine traveling mode. In addition, the engine 1 is stopped in a case where the IG switch 5 is switched off or in a case where the traveling mode is switched from the hybrid mode or the engine traveling mode to the motor traveling mode. The start and stop state in which the traveling mode is switched during the traveling to start and stop the engine 1 may be referred to as an intermittent stop.

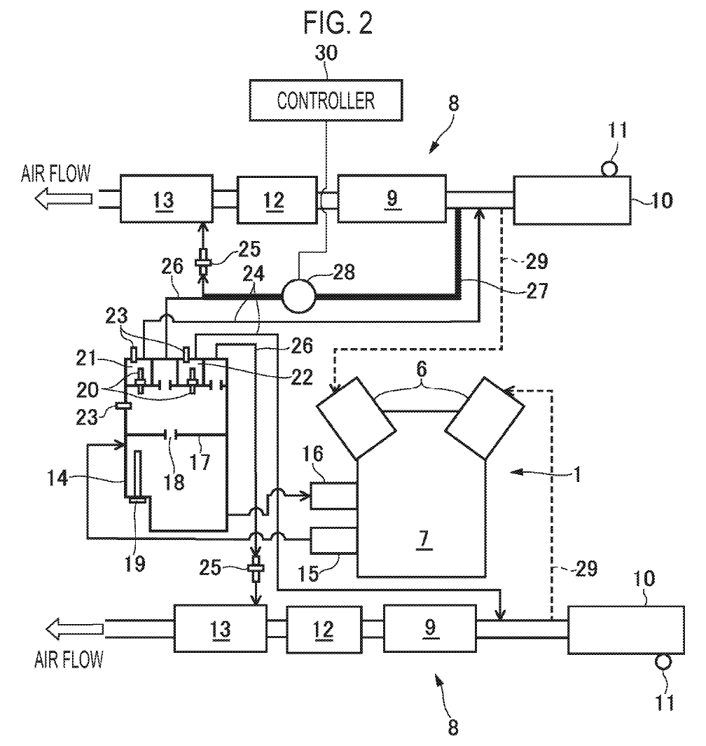

The engine 1 is a dry sump engine, and a configuration thereof is schematically shown in FIG. 2. The example shown in FIG. 2 is an example of a V-type engine, and the engine 1 has two cylinder heads 6, 6 at an upper portion and a crankcase 7 at a lower portion, and these configurations are the same as those of a conventional V-type engine. In addition, the engine 1 is provided with a pair of left and right intake systems 8, 8.

Each of the intake systems 8, 8 has the same configuration, and each of the intake systems 8, 8 is provided with a compressor 9, 9 for supercharging. The compressor 9, 9 may be a compressor of a turbocharger or may be a compressor of a supercharger. An air cleaner 10, 10 communicates with the suction side of the compressors 9, 9, and the engine 1 is configured to suction air from which dust is removed by the air cleaners 10, 10. An air flow meter 11, 11 that measures the amount of air suctioned by the engine 1 is attached to the air cleaner 10, 10 or the vicinity thereof. An intercooler 12, 12 that cools the air is connected to the discharge side of the compressors 9, 9, and the intercoolers 12, 12 are connected to intake manifolds 13, 13 of the engine 1.

On the other hand, an oil tank 14 that receives oil and blow-by gas from the crankcase 7 and temporarily stores the oil and the blow-by gas is provided. The oil tank 14 communicates with the crankcase 7 via a scavenging pump 15 driven by the engine 1. In a state where the engine 1 is driven, the oil and the blow-by gas inside the crankcase 7 are pumped to the oil tank 14 by the scavenging pump 15. In addition, the oil tank 14 is connected to an oil pump 16 driven by the engine 1, and in a state where the engine 1 is driven, the oil in the oil tank 14 is supplied to a demanding part of the engine 1 for lubrication. In the engine 1, the oil supplied to the demanding part for lubrication gradually flows down and is finally accumulated in the crankcase 7.

Since the blow-by gas is sent to the oil tank 14 together with the oil, the inside of the oil tank 14 has a liquid-gas separation structure that separates the oil and the blow-by gas. For example, as shown in FIG. 2, a separator 17 that partitions the inside into upper and lower portions is provided, and the separator 17 is provided with a through-hole 18. The blow-by gas reaches the upper portion of the separator 17 through the through-hole 18, and the oil mist or the condensed oil accumulated on the upper side of the separator 17 drops down to the lower side through the through-hole 18, and thus the gas and the liquid are separated.

A portion below the separator 17 is a so-called oil chamber, and a portion above the separator 17 is a gas chamber, and an oil gauge 19 that measures the amount of oil is provided in the liquid chamber. In addition, a pair of partition chambers 21, 21 including PCV valves 20, 20 and a pair of second partition chambers 22, 22 communicating with the gas chamber through the through-holes are provided at the upper portion of the gas chamber, that is, the upper portion of the oil tank 14. The PCV valve 20 is a valve that is the same as a valve known in the related art, and is a valve that is opened when the pressure of the gas chamber is equal to or higher than a preset pressure. Further, a pressure sensor 23 is provided in each of the gas chamber and the first partition chambers 21, 21.

The first partition chambers 21, 21 communicate with the intake systems 8, 8, more specifically, the suction side of the compressors 9, 9, via communication pipes 24, 24. In a case where the pressure inside the oil tank 14 is equal to or higher than a predetermined pressure, or in a case where the difference between the pressure inside the oil tank 14 and the pressure of the intake systems 8, 8 is equal to or higher than a predetermined value. In this case, the PCV valves 20, 20 are opened to discharge the blow-by gas inside the oil tank 14 to the intake systems 8, 8. In addition, the second partition chambers 22, 22 communicate with the intake systems 8, 8, more specifically, the intake manifolds 13, 13, via communication pipes 26, 26 including PCV valves 25, 25. In a case where the pressure inside the oil tank 14 is equal to or higher than a predetermined pressure by the PCV valves 25, 25, or in a case where the difference between the pressure inside the oil tank 14 and the pressure of the intake systems 8, 8 is equal to or higher than a predetermined value set by the PCV valves 25, 25. In this case, the PCV valves 25, 25 are opened to discharge the blow-by gas inside the oil tank 14 to the intake systems 8, 8.

One of the second partition chambers 22, 22 are connected to the intake systems 8, more specifically, between the air cleaner 10 and the compressor 9, via another communication pipe line 27. A control valve 28 that is electrically controlled to be opened and closed is provided in the communication pipe line 27. The control valve 28 is a valve for preventing the pressure inside the oil tank 14 from excessively decreasing, such as being a predetermined negative pressure. For example, the control valve 28 is a so-called normally closed type valve that is opened by energization and closed by stopping the energization. In FIG. 2, reference numeral "29" indicates a ventilation path. The ventilation path 29 is provided to communicate a portion downstream of the air cleaners 10, 10 with the cylinder heads 6, 6, and is configured to introduce the outside air into the cylinder heads 6, 6 to ventilate the inside of the engine 1. The PCV valves 20, 25 described above correspond to the first valve in the embodiment of the present disclosure, and the control valve 28 corresponds to the second valve.

A controller 30 that controls the control valve 28 is provided. The controller 30 is configured mainly of a microcomputer consisting of a calculation element (CPU), a storage element (RAM, ROM), and an interface. In addition, the controller 30 is configured to perform a calculation according to a program stored in advance by using input data and data stored in advance, and output a result of the calculation as a control command signal. The input data is a signal of the IG switch 5 being turned on or off, a signal of a start request of the engine 1 during traveling in the hybrid mode, a signal of an after-start flag indicating that the engine 1 is driven, and the like. In addition, the input data is a measurement signal from the pressure sensor 23 that measures the pressure inside the oil tank 14, a measurement signal of an atmospheric pressure sensor in a case where the atmospheric pressure sensor is provided, a failure signal in a case where the pressure sensor 23, the atmospheric pressure sensor, or the like fails, and the like. In addition, the data stored in advance is a reference pressure value for determining the pressure inside the oil tank 14, a reference time value for determining a continuous time for controlling the control valve 28 to be in an open state, and the like. The main signal to be output is a signal for opening and closing the control valve 28. The controller 30 may be configured to transmit and receive data to and from the HV-ECU 4.

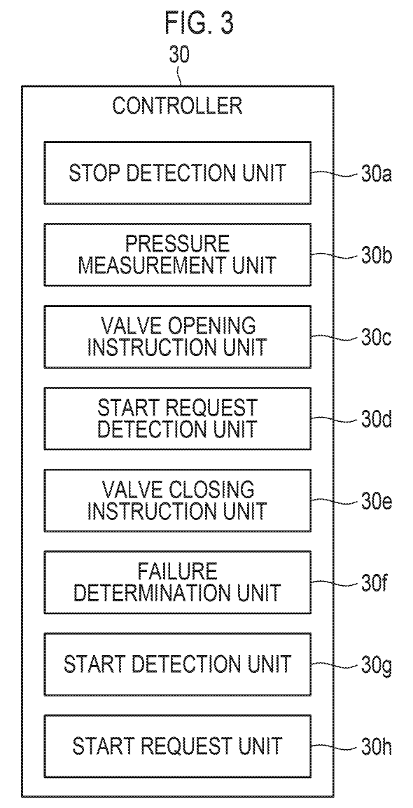

The controller 30 is configured to mainly control the control valve 28 in response to the stop and the start of the engine 1, and for this purpose, the controller 30 includes the following control units or functional configurations. FIG. 3 is a block diagram showing a functional configuration of the controller 30, and includes a stop detection unit 30a that detects that the engine 1 is stopped. The stop of the engine 1 may be detected based on the after-start flag being switched from on indicating the driving state to off indicating the stop state.

In addition, a pressure measurement unit 30b that measures the pressure inside the oil tank 14 is provided. The pressure inside the oil tank 14 is measured by the pressure sensor 23, and the pressure measurement unit 30b measures the pressure based on the measurement signal.

The controller 30 includes a valve opening instruction unit 30c that performs control of opening the control valve 28. The valve opening instruction unit 30c executes control of opening the control valve 28 based on the stop of the engine 1 and the fact that predetermined conditions, such as a low pressure inside the oil tank 14, are satisfied.

The controller 30 further includes a start request detection unit 30d. The start request detection unit 30d is a functional configuration that detects the start request to start the engine 1, and can detect the start request by, for example, the after-start flag being turned on to indicate the start of the engine 1. A valve closing instruction unit 30e that closes the control valve 28 by the start request being made or other conditions being satisfied is provided.

In addition, the controller 30 includes a failure determination unit 30f that determines that the pressure measurement unit 30b cannot measure the pressure. This determination can be made by the measurement value of the pressure sensor 23 or the atmospheric pressure sensor being abnormally low, being abnormally high, or the difference between the measurement values of these sensors being abnormally large.

The controller 30 further includes a start detection unit 30g that detects that the power supply for starting the engine 1 is turned on. The power supply of the engine 1 or an entirety of the hybrid electric vehicle 3 equipped with the engine 1 is turned on by the IG switch 5 being turned on, and the engine 1 or the hybrid electric vehicle 3 is activated. In this state, the HV-ECU 4 determines the start of the engine 1, and the start request of the engine 1 is satisfied. Therefore, the start detection unit 30g may detect that the power supply is turned on by the IG switch 5 being turned on.

The controller 30 further includes a start request unit 30h. The start request unit 30h enables the start of the engine 1 based on the pressure inside the oil tank 14 being increased to a predetermined pressure in a case where the engine 1 is started.

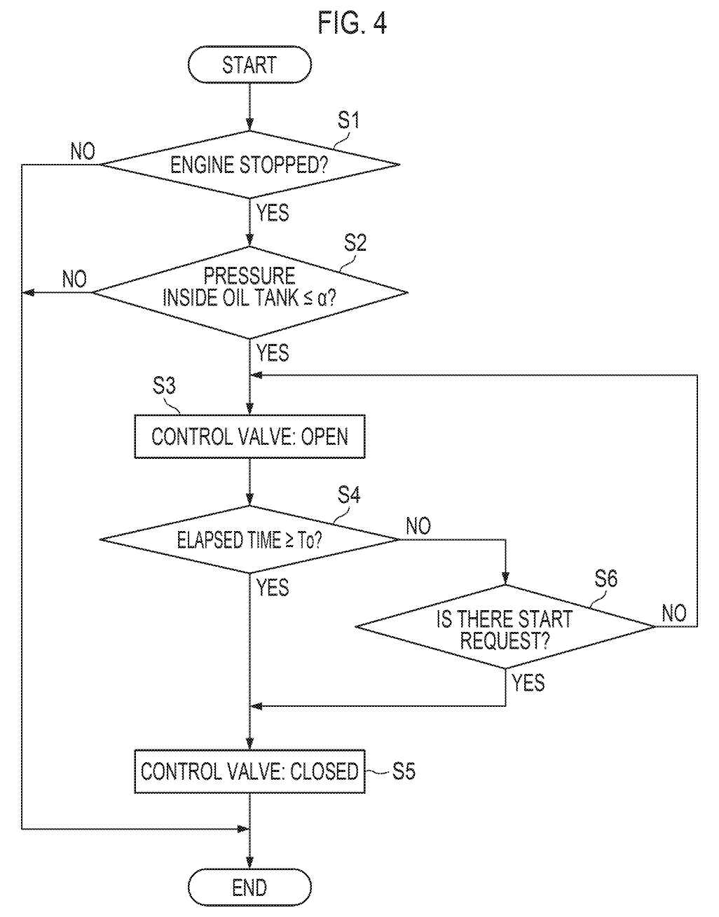

An example of the control by the controller 30 will be described below. FIG. 4 is a flowchart for describing an example of the control, and the example shown here is an example of a case where the engine 1 is stopped during the hybrid traveling by repeatedly executing the control in a predetermined short time during the hybrid traveling. In S1, determination is made whether the engine 1 is stopped and the rotation is stopped based on the request to stop the engine 1. The control of S1 is executed by the stop detection unit 30a of the controller 30.

In a case where the determination result of S1 is "No", the routine shown in FIG. 4 is temporarily ended without performing any control. On the other hand, in a case where the determination result of S1 is "Yes", in S2, determination is made whether the pressure inside the oil tank 14 is equal to or lower than a predetermined pressure α. The control of S2 is executed by the pressure measurement unit 30b of the controller 30.

In a case where the determination result of S2 is "No", since the oil tank 14 does not have a possibility of suctioning the oil, the blow-by gas, or the like, the routine shown in FIG. 4 is temporarily ended without performing any control. On the other hand, in a case where the determination result of S2 is "Yes", the control of opening the control valve 28 is executed in S3. That is, a control command signal for opening the control valve 28 is output. The control of S3 is executed by the valve opening instruction unit 30c of the controller 30.

Next, in S4, determination is made whether the elapsed time after executing the control of opening the control valve 28 is equal to or longer than a predetermined time To, that is, whether the predetermined time has elapsed. The predetermined time To is a time obtained in advance by an experiment, a simulation, or the like as a sufficient time for the oil tank 14 to suction the air from the intake system 8 and increase the pressure inside the oil tank 14 to the atmospheric pressure.

In a case where the determination result of S4 is "Yes", the control of closing the control valve 28 is executed in S5, and then the control shown in FIG. 4 is temporarily ended. Since the control valve 28 is a so-called normally closed type valve, the control valve 28 is closed by blocking the energization to the control valve 28. The control of S5 is executed by the valve closing instruction unit 30e of the controller 30.

Therefore, according to the control shown in FIG. 4, the inside of the oil tank 14 is in a negative pressure lower than the atmospheric pressure in a case where the engine 1 is about to stop and the engine 1 is suctioning the air. Even in a case where the engine 1 is stopped and the PCV valves 20, 20, 25, 25 are closed in this state, the control valve 28 is opened to suction the air from the intake system 8 in a case where the engine 1 is stopped. Moreover, the control valve 28 is controlled to be in the open state for a time sufficient for the oil tank 14 to sufficiently suction the air. Therefore, according to the above control, it is possible to reliably avoid the pressure inside the oil tank 14 from being excessively low. In addition, since the control valve 28 is connected to the intake system 8, even in a case where the control valve 28 is broken in an open state, the blow-by gas in the oil tank 14 is not leaked to the outside through the intake system 8 and is not sucked by the engine 1.

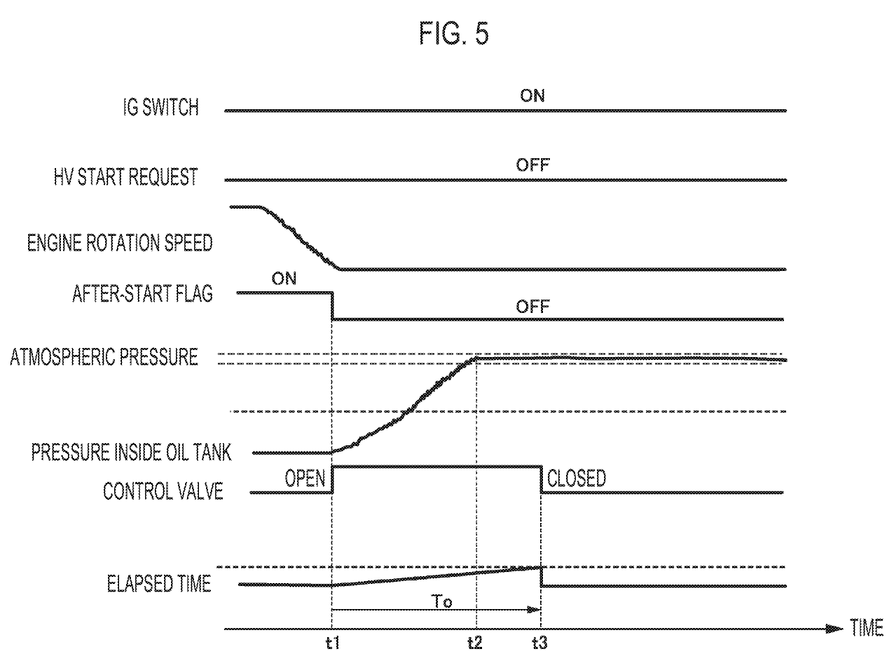

FIG. 5 is a time chart showing a change in the state of the hybrid electric vehicle 3 in a case where the above control is performed. FIG. 5 shows changes in each of the state of the IG switch 5, the state of the start request of the engine 1 in the hybrid mode, the engine rotation speed, and the after-start flag of the engine 1. In addition, changes in each of the pressure inside the oil tank 14, the open or closed state of the control valve 28, and the elapsed time after controlling the control valve 28 to be in the open state are shown.

The IG switch 5 is turned on, and the determination that the engine 1 is stopped during the traveling is satisfied, the driving of the engine 1 is stopped, and the engine rotation speed is decreased, and finally the rotation of the engine 1 is stopped. That is, the rotation of the engine 1 is stopped, and the engine 1 is stopped. This is a t1 point in time of FIG. 5, and in the control of FIG. 4, the determination result of S1 is "Yes". Accordingly, the after-start flag is switched from on to off. In a case where the pressure inside the oil tank 14 at this point in time is equal to or lower than the predetermined pressure α, the control valve 28 is opened. These controls are the controls of S2 and S3 in the control shown in FIG. 4.

Since the oil tank 14 suctions the air from the intake system 8 by opening the control valve 28, the pressure inside the oil tank 14 is gradually increased, and finally the pressure is increased to the atmospheric pressure. This is a t2 point in time in FIG. 5. Since the control valve 28 is so-called timer-controlled, the control valve 28 is still controlled to be in the open state at the t2 point in time, and thus the pressure inside the oil tank 14 is increased to a pressure substantially equal to the pressure of the intake system 8, more specifically, the pressure on the suction side of the compressor 9. Thereafter, the control valve 28 is closed at a t3 point in time after the predetermined time T0 has elapsed. These are the controls of S4 and S5 in the control of FIG. 4.

On the other hand, in a case where the determination result of S4 in FIG. 4 is "No", the process proceeds to S6, and determination is made whether there is a request to start the engine 1. In a case where the determination result of S6 is "No" because there is no start request, the process returns to S3, and the control of bringing the control valve 28 into the open state is continued. On the contrary, in a case where the determination result of S6 is "Yes", the control valve 28 is closed in S5, and the control shown in FIG. 4 is temporarily ended. The control of S6 is executed by the start request detection unit 30d of the controller 30.

In this case, the elapsed time from the start of controlling the control valve 28 to be in the open state has not reached the predetermined time To, and the pressure inside the oil tank 14 is not sufficiently high. However, the amount of air suctioned by the engine 1 is measured by the air flow meter 11 provided in the air cleaner 10 or the vicinity thereof. Since the blow-by gas flowing from the oil tank 14 through the communication pipe line 27 does not mix into the measured air, it is possible to avoid a problem in the driving of the engine 1.

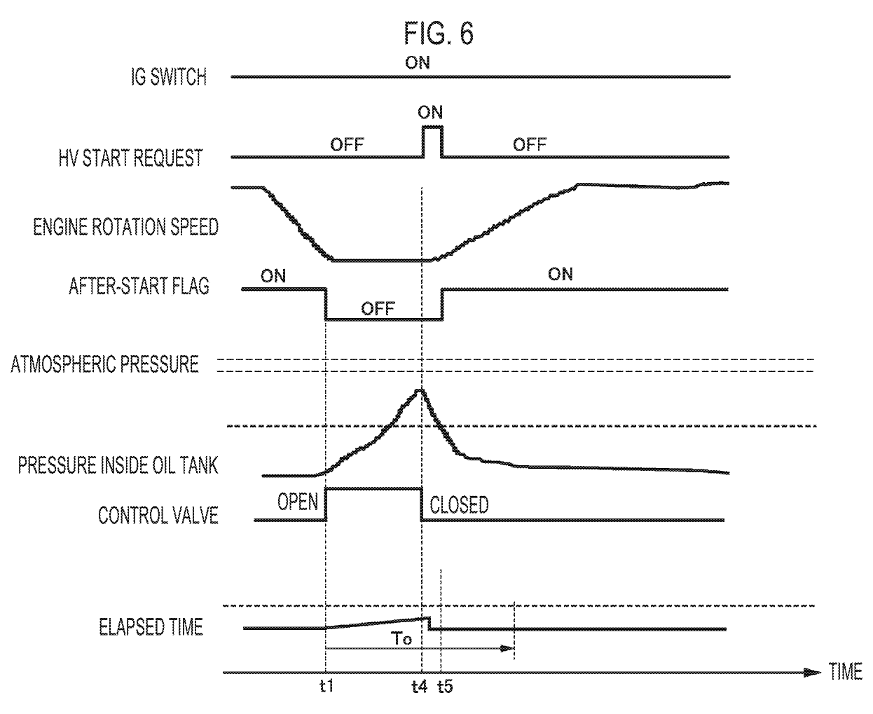

FIG. 6 is a time chart showing a change in the state of the hybrid electric vehicle 3 in a case where the determination result of S6 is "Yes". In FIG. 6, at a t1 point in time, the control valve 28 is opened, and at a t4 point in time before the elapsed time reaches the predetermined time To, there is a start request of the engine 1 in the HV-ECU 4. In this case, as shown in FIG. 6, the start request is temporarily turned on, and the control valve 28 is closed in response to the start request. At a t5 point in time after that, the after-start flag is switched on.

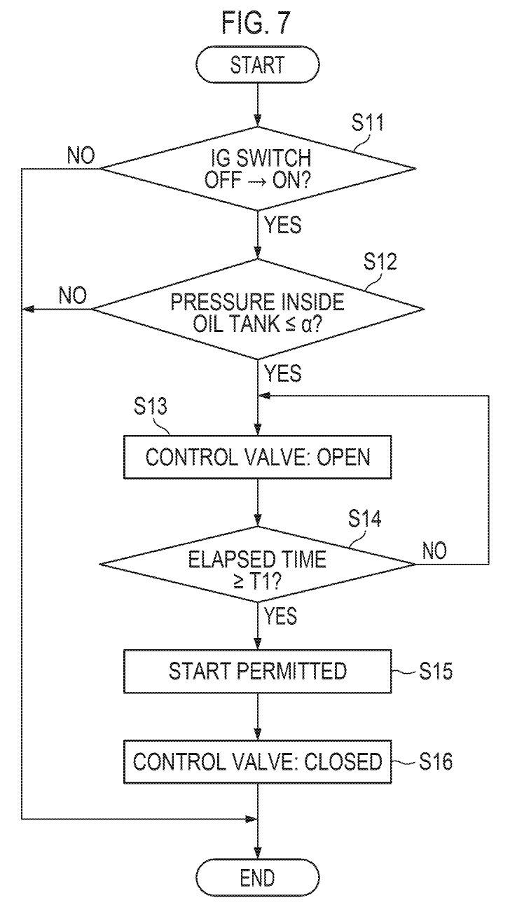

Next, an example of the control in a case where the pressure inside the oil tank 14 is low in a case where the IG switch 5 is turned on will be described. FIG. 7 is a flowchart showing an example of the control. First, in S11, determination is made whether the IG switch 5 is switched from off to on. In a case where the determination result is "No", the control shown in FIG. 7 is temporarily ended without performing any control. On the contrary, in a case where the determination result of S11 is "Yes", the process proceeds to S12, and determination is made whether the pressure inside the oil tank 14 is equal to or lower than the predetermined pressure α. The control of S11 is executed by the start detection unit 30g of the controller 30, and the control of S12 is executed by the pressure measurement unit 30b of the controller 30.

In a case where the determination result of S12 is "No", the control shown in FIG. 7 is temporarily ended without performing any control. On the contrary, in a case where the determination result of S12 is "Yes", the control valve 28 is energized and opened in S13. Next, in S14, determination is made whether the elapsed time after opening the control valve 28 has reached the predetermined time T1.

In a case where the determination result of S14 is "No", the process returns to S13, and the control of bringing the control valve 28 into the open state is continued. On the contrary, in a case where the determination result of S14 is "Yes", the start of the engine 1 is permitted in S15. The control is executed by the start request unit 30h. The pressure inside the oil tank 14 is increased to the atmospheric pressure or the pressure of the intake system 8 by executing the control of opening the control valve 28 as described above. Then, in S16, the control of closing the control valve 28 is executed in preparation for the start of the engine 1.

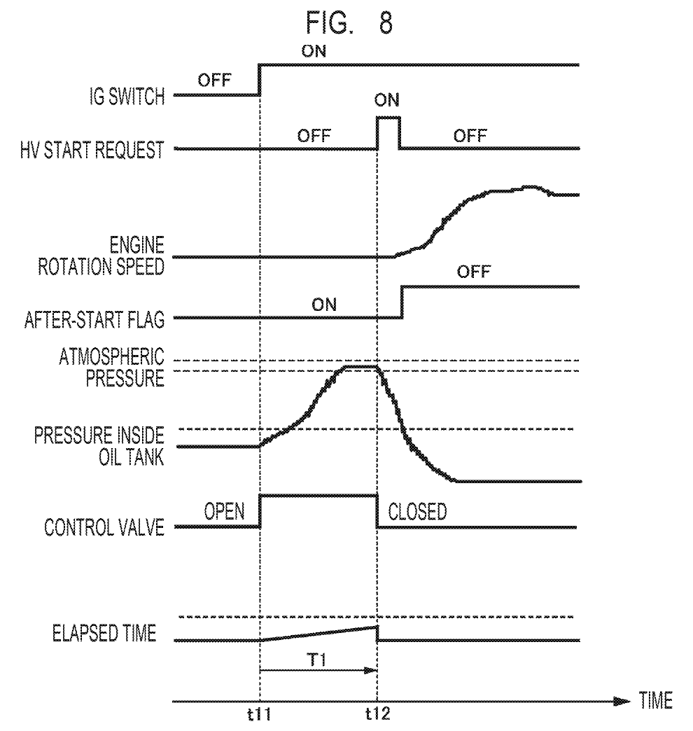

FIG. 8 is a time chart showing a change in the state of the hybrid electric vehicle 3 in a case where the control shown in FIG. 7 is performed. In FIG. 8, in a case where the IG switch 5 is switched from off to on at a t11 point in time, the power supply is turned on, and the entirety of the hybrid electric vehicle 3 is in a so-called active state. At the same time, the pressure inside the oil tank 14 is measured, and in a case where the pressure is lower than the predetermined pressure, that is, in a case where the determination in S12 of FIG. 7 is "Yes", the control valve 28 is energized and controlled to be in the open state. This is the control of S13 in FIG. 7.

The control valve 28 is closed at a t12 point in time after the predetermined time T1 has elapsed from the t11 point in time at which the control valve 28 is controlled to be in the open state. This is the control of S16 in FIG. 7. Therefore, the oil tank 14 suctions the air from the intake system 8 for the predetermined time T1, so that the pressure is increased to the atmospheric pressure or the pressure of the intake system 8, and the excessively low negative pressure is eliminated. At the same time, the engine 1 is brought into a state where the start is possible, and in the example shown in FIG. 8, the start request of the engine 1 in the HV-ECU 4 is turned on.

According to the control shown in FIG. 7, in a case where the engine 1 is started, the excessively low negative pressure of the oil tank 14 is eliminated. Therefore, it is possible to avoid the oil tank 14 from suctioning the oil together with the blow-by gas or from causing the insufficient lubrication for this reason. In addition, in a case where the engine 1 is started, it is possible to avoid the blow-by gas flowing from the oil tank 14 through the communication pipe line 27 from mixing into the air measured by the air flow meter 11. That is, the control of the engine 1 can be stabilized.

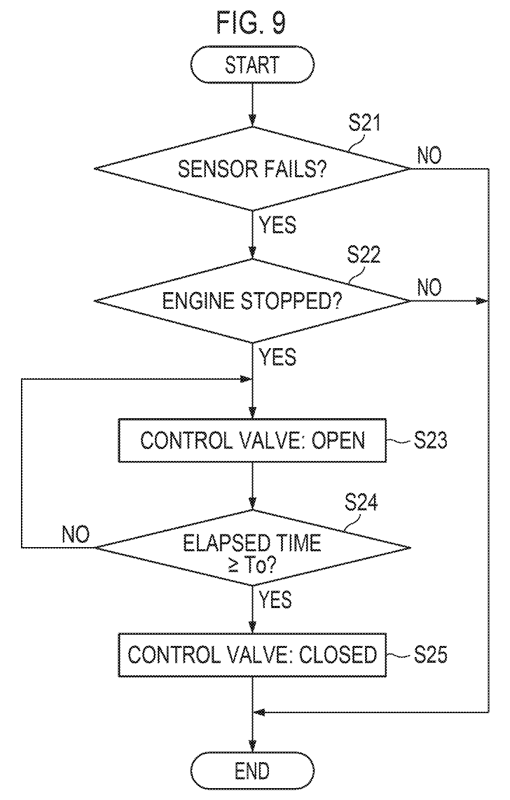

Each of the above-described control examples is a control example of opening and closing the control valve 28 based on the detection that the pressure inside the oil tank 14 is excessively low. Therefore, in a case where the failure occurs in which the pressure sensor 23 or the atmospheric pressure sensor (not shown) cannot measure the pressure, the opening and closing control of the control valve 28 cannot be performed. In such a case, in the embodiment of the present disclosure, the following control is executed. FIG. 9 is a flowchart for describing the control example, and is a control in a case where the IG switch 5 is turned on and there is no start request of the engine 1 in the hybrid mode. The control shown in FIG. 9 is repeatedly executed for each predetermined short time, and first, in S21, determination is made whether there is a failure in the sensor that measures the pressure. This determination can be performed, for example, by the controller 30 receiving a result of a failure diagnosis by a computer (not shown) that controls the entirety of the hybrid electric vehicle 3. Alternatively, the failure can be determined by the controller 30 determining that the pressure indicated by the signal input to the controller 30 is a pressure that cannot occur under normal circumstances. The control of S21 is executed by the failure determination unit 30f of the controller 30.

In a case where the determination result of S21 is "No", the control shown in FIG. 9 is temporarily ended without performing any control. On the contrary, in a case where the determination result of S21 is "Yes", determination is made in S22 whether the engine 1 is stopped. This control is the same as the control of S1 in FIG. 4.

In a case where the determination result of S22 is "No", the control shown in FIG. 9 is temporarily ended without performing any control. On the contrary, in a case where the determination result of S22 is "Yes", the control of opening the control valve 28 is executed in S23. This control is the same as the control of S3 in FIG. 4 or the control of S13 in FIG. 7.

Next, in S24, determination is made whether the elapsed time after controlling the control valve 28 to be in the open state has reached the predetermined time To. This control is the same as the control of S4 in FIG. 4.

In a case where the determination result of S24 is "No", the process returns to S23, and the control of bringing the control valve 28 into the open state is continued. On the contrary, in a case where the determination result of S24 is "Yes", the control of closing the control valve 28 is executed in S25. This is the same control as the control of S5 in FIG. 4 or the control of S16 in FIG. 7. After S25, the control shown in FIG. 9 is temporarily ended.

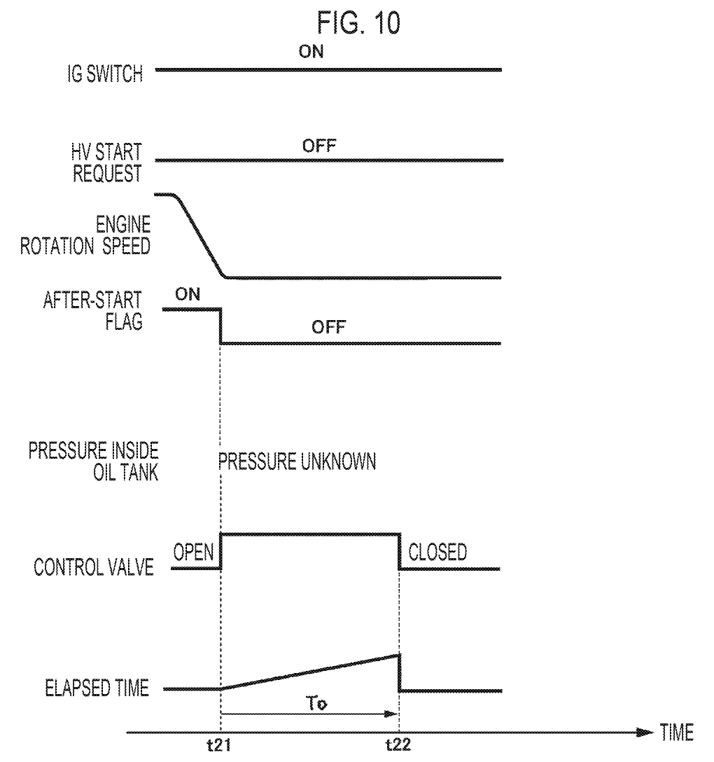

FIG. 10 is a time chart showing a change in the state of the hybrid electric vehicle 3 in a case where the control shown in FIG. 9 is performed. In a case where the after-start flag is turned off and the determination that the engine 1 is stopped is satisfied at a t21 point in time in a state where the pressure inside the oil tank 14 is unknown due to the failure of the sensor, the control valve 28 is controlled to be in the open state. In this case, the pressure inside the oil tank 14 is unknown, but in a case where the pressure inside the oil tank 14 is low, the air is suctioned from the intake system 8 to the oil tank 14 by opening the control valve 28. Therefore, the pressure inside the oil tank 14 is increased to the atmospheric pressure or the pressure of the intake system 8. On the contrary, in a case where the pressure inside the oil tank 14 is increased to the atmospheric pressure or the pressure of the intake system 8, the air is not suctioned and the pressure change does not occur even in a case where the control valve 28 is opened. However, the pressure inside the oil tank 14 can be maintained at the atmospheric pressure or the pressure of the intake system 8.

In a case where the predetermined time To has elapsed, the negative pressure inside the oil tank 14 can be substantially eliminated in a case where the pressure inside the oil tank 14 is the negative pressure, so that the control valve 28 is closed at a t22 point in time after the predetermined time To has elapsed. Therefore, according to the control shown in FIG. 9, it is possible to prevent an excessively low negative pressure of the oil tank 14 due to the stop of the engine 1, the suction of the oil by the oil tank 14 due to the excessively low negative pressure, abnormal noise due to the suction, and the like.

Although the embodiment of the present disclosure has been described above, the present disclosure is not limited to the above-described embodiment, and can be appropriately changed and implemented as necessary. For example, the control valve may be provided corresponding to each of the intake systems. In addition, the form of the engine and the internal structure of the oil tank are not limited to those shown in the above-described embodiment. Therefore, the engine may not be an engine that is supercharged by the compressor.

What is claimed is:

1. A control device for an internal combustion engine that outputs power by combusting an air-fuel mixture of air suctioned through an intake system and fuel, the internal combustion engine including an oil tank that receives oil for lubricating the internal combustion engine and a blow-by gas generated by combustion from the internal combustion engine, stores the oil and the blow-by gas, and returns the oil to the internal combustion engine, the internal combustion engine being provided with a first valve that is opened in a case where a pressure inside the oil tank is increased and discharges a gas from the oil tank to the intake system, the control device comprising:
a second valve that is controlled to open and close a communication pipe line that causes the oil tank and the intake system to communicate with each other; and
a controller configured to control the second valve,
wherein the controller includes
a stop detection unit configured to detect that the internal combustion engine is stopped,
a pressure measurement unit configured to measure a pressure of the oil tank when the internal combustion engine is stopped, and
a valve opening instruction unit configured to open the second valve for a period specified in advance to introduce the air of the intake system to the oil tank in a case where the pressure measured by the pressure measurement unit is equal to or lower than a pressure specified in advance.

2. The control device according to claim 1, wherein the period specified in advance is any of a period until the pressure of the oil tank is increased to the pressure specified in advance or a time specified in advance that elapses after the second valve is opened.

3. The control device according to claim 1, wherein the controller further includes
a start request detection unit configured to detect that there is a start request to start the internal combustion engine, and
a valve closing instruction unit configured to close the second valve in a case where the start request detection unit detects that there is the start request during the period specified in advance.

4. The control device according to claim 1, wherein:
the controller further includes a failure determination unit configured to determine that the pressure measurement unit fails to measure the pressure; and
the valve opening instruction unit is configured to open, in a case where the failure determination unit determines that the pressure measurement unit fails to measure the pressure, the second valve for a time specified in advance when the internal combustion engine is stopped.

5. A control device for an internal combustion engine that outputs power by combusting an air-fuel mixture of air suctioned through an intake system and fuel, the internal combustion engine including an oil tank that receives oil for lubricating the internal combustion engine and a blow-by gas generated by combustion from the internal combustion engine, stores the oil and the blow-by gas, and returns the oil to the internal combustion engine, the internal combustion engine being provided with a first valve that is opened in a case where a pressure inside the oil tank is increased and discharges a gas from the oil tank to the intake system, the control device comprising:
a second valve that is controlled to open and close a communication pipe line that causes the oil tank and the intake system to communicate with each other; and
a controller configured to control the second valve,
wherein the controller includes
a start detection unit configured to detect that a power supply for starting the internal combustion engine is turned on,
a pressure measurement unit configured to measure a pressure of the oil tank at a time point when the start detection unit detects that the power supply is turned on, and
a valve closing instruction unit configured to open the second valve in a case where the pressure measurement unit detects that the pressure of the oil tank at the time point when the start detection unit detects that the power supply is turned on is equal to or lower than a pressure specified in advance, and then close the second valve in a case where the pressure of the oil tank is increased to a predetermined pressure.

6. The control device according to claim 5, wherein the controller further includes a start request unit configured to enable start of the internal combustion engine in a case where the valve closing instruction unit issues an instruction to close the second valve.
